(19) United States
(12) Patent Application Publication
(10) Pub. No.: US 2013/0024213 A1
(43) Pub. Date: Jan. 24, 2013

(54) METHOD AND SYSTEM FOR GUIDED, EFFICIENT TREATMENT

(71) Applicant: Michael Poon, Harrington Park, NJ (US)

(72) Inventor: Michael Poon, Harrington Park, NJ (US)

(73) Assignee: THE RESEARCH FOUNDATION OF STATE UNIVERSITY OF NEW YORK, Albany, NY (US)

(21) Appl. No.: 13/638,487

(22) PCT Filed: Mar. 24, 2011
(86) PCT No.: PCT/US11/29803

§ 371 Date: Sep. 28, 2012

Related U.S. Application Data
(60) Provisional application No. 61/317,690, filed on Mar. 25, 2010.

(51) Int. Cl. G06Q 50/24

(52) U.S. Cl. 705/3

(57) ABSTRACT

A system and method is provided in which medical treatment of a patient is effected in a systematic and guided fashion. From a patient's symptoms and electronic medical record, a specific diagnostic test may be recommended. Upon execution of the diagnostic test, the diagnostic scan results may be forwarded to a remote location for assistance in analysis. Once analyzed, the results are transmitted to the attending medical personnel. The results, and information which led to the decision to have a diagnostic test, are also sent to a repository for use in future diagnoses and other determinations. A monitor or dashboard is used to keep track of the various steps of the procedure, to provide on the job guidance in using a diagnostic test device, and the ensure a specific efficiency and protocol are followed. A remote location of experts may also be monitoring the dashboard, as a quality control.

### CROSS REFERENCE TO RELATED APPLICATIONS

This International application claims the benefit under 35 U.S.C. 119(e) of U.S. Provisional Application No. 61/317,690, filed Mar. 25, 2010, the entire contents of the above referenced application being incorporated herein by reference.

### BACKGROUND OF THE INVENTION

The present invention relates generally to a system for the administration of and support of administering diagnostic care to patients. Various symptoms experienced by individuals may be at least in-part diagnosed using an imaging device. For example, acute chest pain is presently a major health issue, constituting several million emergency department (ED) visits annually in the United States. The present standard of care for diagnosing such, e.g., chest pain, involves using serial blood tests and stress tests. Such tests, often administered in sequence, are time consuming, costly, and not always accurate.

Of the several million ED visits annually concerning acute chest pains, the majority of the cases are found to be false alarms. Each visit can cost a hospital a few thousand dollars at a minimum, and several hours of medical personnel time. Further, crowding in emergency rooms is a growing concern and patients with ailments needing attention may have to wait several hours before being treated. Unfortunately, the current standard of care for certain symptoms can sometimes miss the true or underlying cause for a set of presented symptoms. For example, the current standard of care for chest pain using stress testing often misses the presence of significant coronary disease. As a result, besides the detriment to the patients, hospitals may incur liability and a poor reputation for misdiagnosing patients—both false positive and negative.

Diagnostic test devices provide more accurate, efficient systems for diagnosing, but oftentimes hospitals and medical centers lack sufficient personnel trained in using such devices. For example, while a multi-detector computed tomography device is believed to be one of the most accurate non-invasive diagnostic imaging tests available for ruling out the presence of coronary artery disease, among other things, only a very small number of practicing physicians and technicians are currently qualified to operate and interpret computed tomography angiography (CTA) or other diagnostic imaging test devices.

Further, since many emergency departments and other locations lack a resident expert of the computed tomography (CT) device or other diagnostic imaging test devices, there exists a need for guidance through the use of such devices as well as expert assistance in the proper reading and analysis of the scan results. Accordingly, the present invention provides systems and methods for a streamlined qualified, timely and cost efficient use of available protocol(s) and/or diagnostic devices, for example, by hospitals and other service providers.

### SUMMARY OF THE INVENTION

Embodiments of the present invention provide for a system and method in which diagnostic events are handled in an accurate, expedient and efficient manner. Preferred embodiments employ a computer implemented process in which critical patient attributes are entered into the patient's medical record to provide an assessment of the need for one or more diagnostic processes that can be used to accurately diagnose the condition of the patient. The system can be programmed to require entry of information regarding the patient's condition that will subsequently be used to select the proper diagnostic sequence. The system will consequently reduce or eliminate the use of diagnostic procedures that do not match the symptoms of the patient. In the case of a CT scan, for example, it will enhance the selection of proper scan parameters that will serve to minimize the radiation dose to which the patient is exposed and also reduce the need to repeat the scan which results in further unwanted radiation exposure and cost.

Thus, preferred embodiments of the invention utilize at least one diagnostic scanning system for imaging a patient. The scanning system has at least one processor to process image data and that transmits and receives information via a communication network. The network provides for data exchange between the scanning systems and a medical record system that includes a patient management sub-system. The patient management system involves the entry of patient data and the selection of scanning protocols to be described in great detail herein.

In embodiments, the symptoms and medical record of an entity, e.g., a mammalian subject, such as a patient, are identified. The patient may be in a first location, e.g., an emergency department (ED) of a hospital or clinic. In reviewing the initially identified symptoms and medical record/history of the patient, a specific diagnostic test may be run. For example, in the situation of a patient complaining of chest pain, and based on that patient's earlier visit to the ED for a similar reason, medical personnel may determine, based on the protocol of the specific ED or medical center, that a diagnostic test such as a computed tomography (CT) scan of the patient's heart should be run. Because computed tomography machines can have numerous parameters that must be selected to run and review the resulting image data accurately, embodiments of the present invention provide for a monitoring system to initially determine a potential need for such a diagnostic test, and then guides one or more medical personnel through the administration of the diagnostic test and review of the subsequent results.

In embodiments of the present invention, such guiding can be conducted via a dashboard. The dashboard can be a displayed image or sequence of images that are displayed on an electronic display. This can be the display on a computer workstation, a portable or mobile computing device, such as a handheld computer, or telephone display. In embodiments, such guiding can be conducted at the same location as the patient and/or medical personnel, or at a remote location separate from the patient and/or medical personnel. For example, a separate medical center having experts in the use of the specific diagnostic machine and analysis of the subsequent results can be called manually, or alerted automatically, in an embodiment of the present invention. The data or diagnostic test results are reviewed at the remote location, and the analysis is then transmitted to the patient's and/or hospital location. The remotely located expert can monitor the scan by receiving the measurement parameters and images in real time during acquisition, and can alter the procedure remotely

In embodiments of the present invention, the dashboard is used as a device to monitor the various steps of the medical procedure. For example, the dashboard is a graphical user interface which displays each of the steps of the procedure, such as, prepare patient for CT scan, apply CT scan, analyze the CT scan, transmit the CT scan to a remote analysis center, consult with remote analysis center, determine diagnosis of patient based on the consult and analysis. In embodiments, the dashboard shows each of the steps of the procedure, and shows either directly and/or through request information regarding each of the steps. For example, if the first two steps have taken place, those steps on the user interface may be shown differently from the other remaining steps. For example, the completed steps have a notation which indicates that the steps are completed, or are grayed out in color. The step currently in action can be shown in a bright color and/or notation indicating that that particular step is the current step. The subsequent steps to be completed, likewise, can have a text and/or color notation indicating that those steps are still to be completed.

Thus, preferred embodiments of the present invention serve to merge the patient management system and the diagnostic systems used in hospitals and clinics in order to more efficiently use those resources in a safe manner for the benefit of patients. Currently, these systems are not well integrated, requiring extensive manual entry of data that is subject to human error or in poor decision making. For example, cardiac stress tests remain widely used for the assessment of patients arriving at emergency rooms with acute chest pain. These tests have remained only partially effective in the accurate assessment of these conditions. CT angiography has improved the diagnostic capabilities in comparison to the stress test, however, these systems are not integrated into the patient management systems of emergency departments.

In embodiments, the user interface allows for pop-up windows or different display screens which provide more information regarding one or more of the identified steps. For example, in a situation where a selected step is the use of a CT device, an authorized user or entity may obtain additional information guiding one through the imaging sequence of the CT device, or other related information. Likewise, the user interface may be linked to transmissions from the diagnostic test machine itself (e.g., CT device) which indicate when the diagnostic test machine is available for use and/or needing maintenance. In embodiments, the user interface allows for pop-up windows or screens which indicate a specific alert, such as an exceeding of a predetermined suggested time to complete a specific step. In embodiments, the pop-up windows or screens can request input by an attending medical personnel for authorization to label a procedure step as completed or other notation. In embodiments, the pop-up windows or screens can request input by an attending medical personnel for actual authorization to view the dashboard and/or additional information therein. In embodiments, such authorization can be in the form of a personal identification number, passcode, smartcard having a passcode, and/or biometric passcode, and/or by any other available means. The system can use a web enabled system in which a website address can be accessed using a public access network such as the internet Using an encrypted access protocol, the user can access the medical record of a particular patient, the active dashboard displaying the current status of the patient undergoing a diagnostic evaluation, as well as the previously acquired results and image data.

In embodiments of the present invention, a resulting review determination is transmitted to the patient's or medical center's location. Such determination may include instructions regarding treatment, a reading and/or analysis of the diagnostic test, e.g., CT scan, and/or other information. The transmission of such review can be effected by any method available, such as facsimile, email, local area network connection, instant messaging (IM), multimedia messaging service (MMS), short messaging service (SMS), teleconference, video conference, and upload/download to a system automatically, etc.

In embodiments of the present invention, the dashboard device and/or display device show the procedure steps, and indicates which method step is currently in progress. In embodiments, the procedure steps are monitored via the dashboard device in real-time for at least one of efficiency, quality, and accuracy.

In embodiments of the present invention, a storage device, e.g., a repository, database, and/or server, is provided to maintain and/or communicate data of the diagnostic test and data of the method steps. In embodiments, the storage device is located at the ED or another department in the hospital, and/or at a remote location such as a medical center or electronic storage facility. In embodiments, the dashboard includes software and/or coded instructions which when implemented by a processor provide for a transmission message or record to be sent to, e.g., the repository, to identify that a specific step of the procedure was completed, not completed, took a certain amount of time to complete, was delayed due to a specific reason (e.g., appropriate personnel was not available to sign off on the step completion), or other information. In embodiments, software and/or coded instructions which when implemented by a processor provide for a generation of at least one report using data from, e.g., the repository. In embodiments, the report concerns efficiency of a process of the method steps; frequency of diagnostic testing; timing of care for the entity; transmission of data; resulting review determinations based on a specific diagnostic test result; and/or transmission of determinations.

In embodiments of the present invention, an apparatus and/or system is provided which includes a monitor, the monitor displaying in real-time the execution of a procedure. In embodiments, the procedure is a medical procedure in which an entity is identified as needing a specific diagnostic test at a location, the diagnostic test is conducted, the data from the diagnostic test is transmitted to another location, the data is analyzed at one or both of the locations, a resulting review determination/analysis is transmitted from the second location to the first location, and the diagnostic test result and analysis are stored in a repository.

In embodiments of the present invention, a monitor is provided to work as a dashboard in which all of the procedural aspects of a system are monitored. In embodiments, the monitor includes a touchscreen so that a user can input a request to obtain more information and/or update the dashboard.

In embodiments of the present invention, a software system and/or coded instructions implemented by a processor provide a graphical interface via a monitor which displays at least one procedure specific to a set of recorded symptoms of an entity. In embodiments, the software system is updated to include information regarding the at least one procedure specific to the set of recorded symptoms of the entity, the information including at least one of appropriate use guidelines, exclusionary criteria, predetermined timing data for respective steps of the at least one procedure, and access permission. For certain diagnostic procedures, the coded instructions can include automated steps in which particular procedures and parameters are selected based on the patient information provided. In embodiments, the updating can be executed asynchronously or synchronously. In embodiments, the updating can be executed through a mobile device, such as a handheld wireless mobile computing device having a display and control panel which is connected to the network with which the graphical user interface communicates.

In embodiments of the present invention, a computer-readable storage medium storing a set of instructions adapted to be executed by a processor to perform a method in which data concerning a patient is inputted and stored, an electronic record (e.g., an electronic medical record (EMR)) associated with the patient is downloaded from a source and stored, the stored data concerning the patient is compared to a pre-inputted list of symptoms and medical history in order to determine if a specific diagnostic test is needed, once the recommended diagnostic test is done then the results can be automatically transmitted or manually authorized to be transmitted via the set of instructions, a communication connection is initialized and/or activated between two or more locations, and/or the resulting analysis of the diagnostic test results are transmitted back to the place administering the diagnostic test.

In embodiments of the present invention, a system for implementation of a medical procedure includes at least one activity monitoring dashboard, the activity monitoring dashboard displaying real-time execution of a medical procedure, the procedure including: identifying a patient for diagnostic test, the patient being located in a first location, conducting a diagnostic test, transmitting resulting data of the diagnostic test to at least one second location, reviewing the diagnostic test at the at least one second location, transmitting a resulting review determination from the at least one second location to the first location, and storing the diagnostic test result in a repository. In embodiments, the activity monitoring dashboard has an interactive screen so that additional information can be displayed for steps of the procedure. In embodiments, the repository is located in the same location as the diagnostic device, and/or at one or more other locations (e.g., medical center, electronic storage facility, hospital, office of the general practitioner of the patient). Embodiments include a report generating system for generating at least one report from data located in the repository concerning at least one of: efficiency of the procedure of the method steps; frequency of diagnostic testing; timing of care for the entity; transmission of data; resulting review determinations based on a specific diagnostic test result; cost of each of the method steps; cost effectiveness of the procedure; and transmission of determinations.

In embodiments, a software system implemented by a processor provides a graphical interface via the activity monitoring dashboard displaying the at least one procedure specific to a set of recorded symptoms of the entity. In embodiments, the software system is updatable to include information regarding the at least one procedure specific to the set of recorded symptoms of the entity, the information including at least one of appropriate use guidelines, exclusionary criteria, predetermined timing data for respective steps of the at least one procedure, an alert if a procedure step exceeds a respective predetermined time data limit, and/or access permission. In embodiments, a portable mobile device is used to communicate with the first location (e.g., hospital ED) and/or communication with or view the activity monitoring dashboard. In embodiments, the communication with or viewing of the activity monitoring dashboard is effected in real-time.

In embodiments of the present invention, the dashboard monitoring activity allows for access to and monitoring of an electronic medical record associated with the entity, a physician ordering system specific to a health care institution, use criteria data identifying an appropriate diagnostic test or intervention for specific symptoms and medical history, alert for any exclusionary criteria for the appropriate diagnostic test or intervention, and alert for each critical checkpoint of the procedure.

Embodiments of the present invention provide for a system and method in which the diagnostic device is a computed tomography machine or multi-detector computed tomography (MDCT) machine.

Embodiments of the present invention provide for a system and method in which the object being imaged is at least one of a body organ, a heart, a lung, a liver, a gall bladder, an eye, an artery, and a brain.

In embodiments, the transmission occurs via at least one of a wired network and a wireless network. The wireless network can be used by physicians, nurses and technicians to access the dashboard on a handheld portable display and computing device.

Embodiments of the present invention provide for a system and method which includes evaluating the transmitted image data file by the location, determining full diagnostics from the transmitted medical imaging data, and transmitting the full diagnostics to at least one of a storage location and a use location.

Embodiments of the present invention provide for a system and method in which the storage location is at least one of a server, a plurality of servers, a storage device, a magnetic strip storage device, a chip storage device. In embodiments of the present invention, the first location is at least one of a hospital, a location from where the image data file was acquired, a university, a clinic, and another evaluation location to check accuracy of the full diagnostics.

In embodiments of the present invention, the evaluation of the transmitted image data is effected by at least one of an urgent care clinic, a large cardiology practice group, a primary care practice group, a hospital, a university, and a location remote from where the image data was acquired.

In embodiments of the present invention, the image data file is compressed further for faster transfer of data via at least one of the Internet and a video conference system, and/or via download to a storage device.

In embodiments of the present invention, various imaging and/or diagnostic test devices, e.g., computed tomography (CT), cardiac magnetic resonance imaging (CMR), electron beam computed tomography (EBCT), electrocardiogram (ECG), myocardial perfusion imaging (MPI), transesophageal echocardiography (TEE) or ultrasound imaging procedure, catheterization procedures, and single-photon emission computed tomography myocardial perfusion imaging (SPECT MPI), can be used. Such devices, when properly used and analyzed may assist in the diagnosis of various illnesses, including, for example, in the cardiology realm, acute coronary syndrome (ACS), coronary artery disease (CAD), coronary heart disease (CHD), heart failure (HF), myocardial infarction (MI), non-ST-segment elevation myocardial infarction (NSTEMI), and ST-segment elevation myocardial infarction (STEMI).

In embodiments of the present invention, sending or transmission of data or information can be via a wired connection or wireless connection to another machine(s), another location(s), or to a data storage location(s) such as a chip card.

Alternatively or in addition to that, such sending or transmission can be via a video conferencing capability in which the images can be viewed as they are being transmitted. The images may then be further processed. For example, such processing can be to convert the files to a viewable state by the remote location. For example, such processing can be used to render a 2-dimensional or 3-dimensional image from the data. Other medical imaging devices (MIP) and/or multiplanar reconstruction devices (MPR) may be used. Once any desired data visualization and/or manipulation takes place, the processed data is sent to, e.g., an expert center. At an expert center, for example, an expert, other qualified individual and/or processing application reviews the processed data to determine a diagnosis. In such a system, the expert center representative or processor may contact the originating source, e.g., a hospital emergency department, for the data with the diagnosis. For example, the processor may send a text message, email, electronic voicemail, and/or page to the intended destination to advise of a recommended diagnosis. Preferred embodiments can also include systems and processes for the training of physician and/or medical technicians.

### BRIEF DESCRIPTION OF THE DRAWINGS

FIG. 1 shows a diagram illustrating an embodiment of the present invention.

FIG. 2A shows a diagram illustrating an embodiment of the present invention.

FIG. 2B shows a computed tomography system used in conjunction with preferred embodiments of the invention.

FIG. 3A shows an example dashboard according to an embodiment of the present invention.

FIG. 3B illustrates a dashboard screen for entry of preliminary data and CT scan protocols.

FIG. 3C illustrates an example of a patient diagnostic data entry image used by the emergency department CTA protocol in accordance with the invention.

FIG. 3D is an example illustrating a physicians' medication order entered into the display for a particular patient CTA imaging sequence.

FIG. 3E illustrates the diagnostic summary including inclusion and exclusion criteria.

FIG. 3F illustrates a plurality of protocols and an associated plurality of scan parameters.

FIG. 4 shows an example dashboard image or screen having a pop-up interface according to an embodiment of the present invention.

FIG. 5 shows an example dashboard image or screen according to an embodiment of the present invention.

FIG. 6 shows a flowchart illustrating an embodiment of the present invention.

FIG. 7A illustrates a remote monitoring graphic user interface in accordance with the invention.

FIG. 7B shows a diagram illustrating a storage process for images and data in accordance with a preferred embodiment of the present invention.

FIG. 8 shows a networked hospital system for patient diagnostic management.

### DETAILED DESCRIPTION OF THE INVENTION

The present invention provide for a systematic approach to the care, diagnosis, and subsequent treatment of a patient. Preferred embodiments employ a computer implemented diagnostic system that is networked to enable a more efficient and safe patient management process for hospitals and clinics.

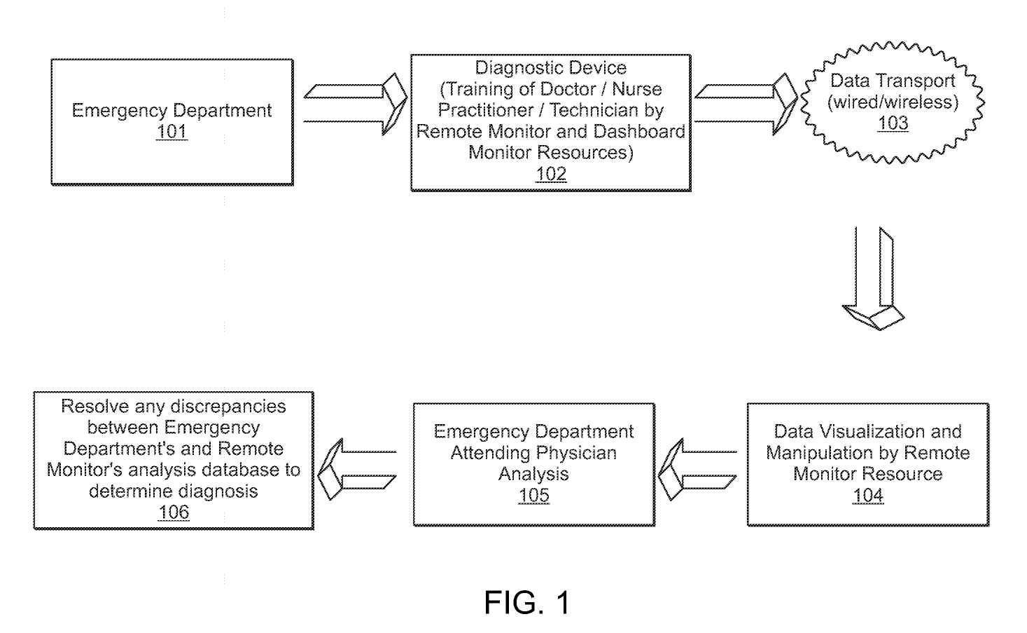

In FIG. 1, a flowchart is shown which illustrates some components of an embodiment of the present invention. For example, a patient suffering from chest pains may go to an emergency medical center for diagnosis and treatment. Upon entering, the patient will be asked for identification so that, among other reasons, his electronic medical record (EMR) can be retrieved. Additionally, the patient or a hospital employee may enter current symptoms being experienced, e.g., the chest pains, by the patient. Alternatively, the patient's symptoms could be entered electronically using one or more sensors which can detect the patient's increased/decreased blood pressure, increased/decreased heart rate, or other symptom(s).

FIG. 1 shows a patient, entering an emergency department 100 of a hospital. Alternatively, the location could be a medical center or other facility having the requisite devices to diagnose a patient. With the use of a processor implementing a software designed to download the patient's EMR and intake the symptoms of the patient, an initial analysis of the patient's condition(s) is made. In embodiments, the initial analysis can be made using software to compare the medical history shown in the patient's EMR and the patient's current symptoms with a predefined table listing a plurality of potential symptoms that may be present. A weighting can occur, based on, e.g., relative importance of each symptom, intensity of each symptom, and/or medical history information, to produce an initially suggested diagnosis and proper test(s) to run to confirm the diagnosis. In the alternative, a straight comparison of all or some of the medical history information and symptoms may be executed to produce an initially suggested diagnosis and/or identify a proper test(s) to run to confirm the diagnosis. In an embodiment, such initial analysis, i.e., high-level evidence indication, can be made by a server or associated diagnostic processor, remote server, and/or expert. In addition, or in the alternative, a remote monitoring communication can be arranged so that an expert or system outside of the immediate location can observe the medical information and symptoms to determine a possible diagnosis to check.

In FIG. 1, when a patient has been admitted to the system, i.e., the patient's information has been entered, then a graphical user interface 102, e.g., a dashboard, is generated by executed software to show the next steps in the patient's current care schedule to a medical personnel. For example, the graphical user interface provides training/guidelines to a medical personnel (e.g., technician) regarding using a specific diagnostic machine; provides access to medical personnel of the patient's symptoms list and/or EMR; provides for real-time monitoring of the past, future, and in progress steps of the patient's care. In an embodiment, the software underlying the graphical user interface keeps track of specific details regarding each step in the patient's care, including time to complete, any delay relative to a table of predefined time limits, any necessary medical personnel needed to authorize start and/or completion of each step, etc. Some or all information thus can be transmitted 103 to a remote location via a wired or wireless method.

Upon initial diagnosis and receiving of appropriate guidelines for the use of the diagnostic machine or tool, the test or measurement is run on the patient, e.g., an image processing scan/3-dimensional rendering/MIP/MPR, 104 of the patient's heart. Using the machine, the specific area of interest can be visualized and manipulated in order to get a clear insight into possible causes for the symptoms. Such test results, e.g., scans of the patient's body organ, are then transmitted or displayed via, e.g., videoconferencing, internet document sharing device, etc., to an entity for accurate reading and analysis 105 of the test results. For example, the test results could be transmitted/viewed via email, facsimile, storage medium, internet-connected server database, temporary cache location, etc. by a remote entity such as an expert reading center. For example, the expert(s) can be connected via video conferencing, web conferencing, teleconferencing and/or other communication network method, as well as through the dashboard, with the attending physician and/or medical personnel(s).

The “expert” entity can include the appropriate expert for reading such tests, such as a cardiologist, radiologist, computer-aided diagnostics and analysis is based on the past history of the patient, aggregate past history of multiple patients, and/or theoretical data. Such expert analysis and eventual diagnosis is then transmitted back to the patient and/or the medical center 106 which conducted the diagnostic tests. For example, a remote center known for its experts on the specific diagnostic machine and area of medicine is used to proffer the diagnosis to an emergency room physician. Such systems involving a remote center provides for additional expert care for a facility which may lack in experienced personnel, or in availability of personnel.

Throughout the procedure, the dashboard keeps all authorized personnel informed on the status of the procedure and treatment of the patient. Authorization access is implemented using an available method (e.g., access code). Further, the dashboard provides for alerts to medical personnel if certain time limits, e.g., effectiveness of a dye administered to a patient is about to decrease, are about to be or are exceeded. In an embodiment, the dashboard is configured to send an electronic page/SMS/MMS/transmission to a medical personnel who is needed and/or due to perform a step in the procedure.

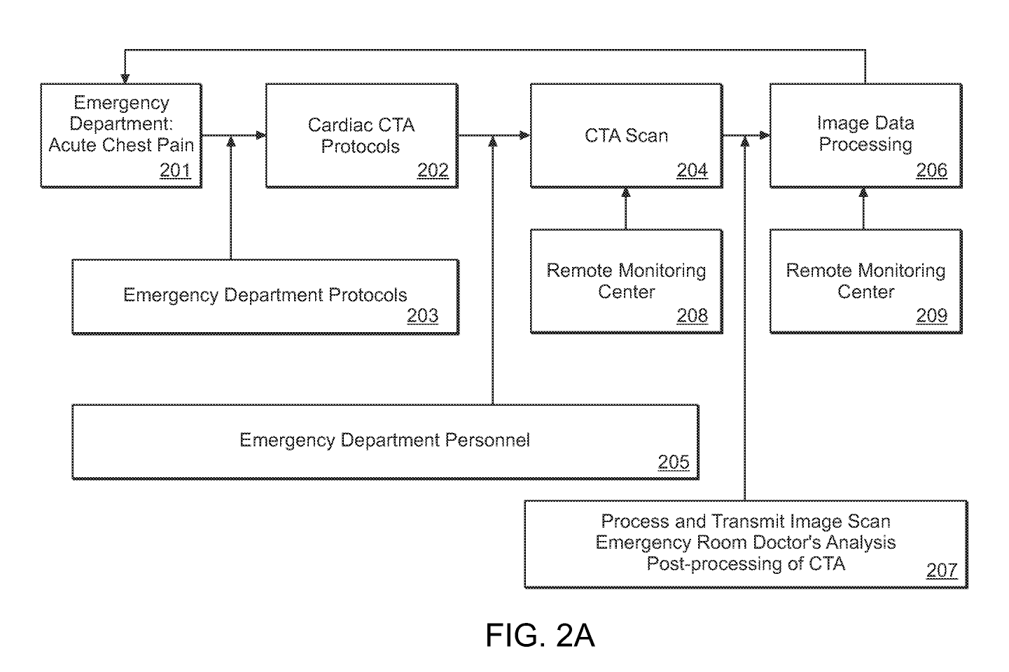

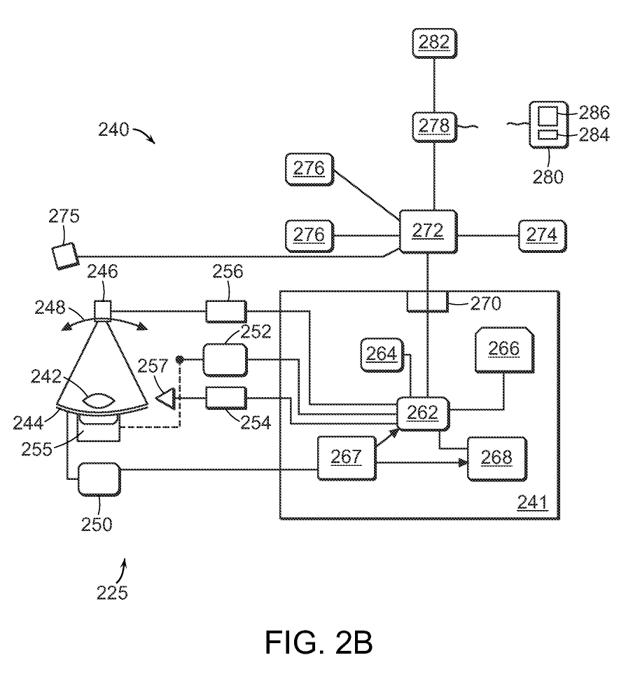

In FIG. 2A, an embodiment of the present invention is shown involving a patient with acute chest pain at an emergency department (ED) or medical center 201. Once the symptoms and EMR of the patient are entered into an electronic database, the software system (executed by one or more processors, the one or more processors located in the same or different locations) compares the symptoms and medical history with one or more lookup tables to determine an initial diagnosis. Once the initial diagnosis is determined, the software system uses that initial diagnosis to obtain or download the ED's protocol 203 for such initial diagnosis. In the alternative, a qualified medical personnel may determine the initial diagnosis and have that entered directly into the software system, either overriding the software's initial diagnosis or adding another possibility of initial diagnosis to be investigated.

For example, if the initial diagnosis is a cardiac disease, then the ED's protocol(s) for cardiac disease is observed and followed. For example, the ED's protocol may indicate that certain criteria and selection processes need to be satisfied 203 before proceeding to use of an imaging device. For example, the ED may have a specific patient selection criteria based on in-use medications, pre-existing diseases and/or allergies, etc. For example, in the case of acute chest pain, the ED may look to the patient's family history of coronary artery disease, existence of diabetes, smoking habits, aspirin use, sedentary lifestyle, congestive heart failure history, cardiac arrest history, asthma, pacemaker/defibrillator, chronic kidney disease, etc.

For example, the ED may follow appropriate use criteria published by a recognized group authority or diagnostic machine manufacturer. For example, in the case of acute chest pain, appropriate use criteria may include: low/intermediate/high pre-test probability of CAD, no ECG changes and serial enzymes negative, etc. For example, the ED may require review of exclusion criteria which may “automatically” prevent a patient from being an appropriate candidate for a specific diagnostic test. For example, in the case of acute chest pain, exclusion criteria may include: history of documented coronary artery disease (e.g., stent, bypass surgery, etc.), heart rate staying at a rate greater than a specified amount even after administration of appropriate medication, known history of contrast reaction, renal insufficiency, inability of patient to cooperate with scan acquisition (e.g., hold breath instructions), clinical instability, etc.

Once a patient has succeeded in being selected for a diagnostic test, then the specific protocol rules for the diagnostic test are identified and followed 202. For example, the software system then identifies on the dashboard the various steps needed to prepare the patient for an, e.g., CTA scan. For example, the software system then identifies the specific or specific types of personnel needed for each of the various steps 205. For example, a notification process is implemented to alert each of the personnel needed at their appropriate times, including, e.g., early alerts and overtime alerts. For example, the various steps may include an ED nursing order in which IV/oral beta blocker/SL NTG is needed for administering. Such administering can be done manually by a nurse or other qualified personnel, or can be done by an automatic dispenser associated with the patient. For example, the various steps may include information for the CT technician, including how to effectively prepare the room, use the ECG monitor, and handle the scanning protocol selection; For example, the various steps may include information for the radiologist/ACPD regarding instructions for patient preparation and scanning. For example, the various steps may include information for the cardiac CTA NP observing the patient preparation and scanning.

After a patient is prepared, the software system tracks the procedure to the actual activation of the diagnostic tool, e.g., CTA scan. In an embodiment, during the scan, in order to assist in the expertise of using the diagnostic tool, a remote monitoring of the scanning process occurs. For example, such monitoring can occur using the various methods described herein, and/or also using a webcam, videoconferencing system, and/or telephone/VoIP connection. Subsequent to the acquisition of the image scans, the ED or remote monitoring location processes the images, and the data is obtained by one or both of the ED and remote monitoring location 207. For example, in the acute chest pain example, a radiologist/ACPD may be required to provide CTA diagnosis, and/or a cardiac CTA NP observation unit ensures that basic CTA post processing occurs. For example, in the acute chest pain example, a technician conducts the calcium scoring and ventricular function calculation. Alternatively, the technician or other medical personnel may input or execute an imaging process software to observe and determine such calcium scoring and ventricular function calculations. Thus, the image data processing occurs 206, whether onsite and/or at a remote location, and the patient may be provided with the observed results, a physician's order of medication, recommended surgery or other treatment, lifestyle changes, and/or a clean bill of health, and next steps. In embodiments, the dashboard is configured to follow the procedure through to post image data processing, including, e.g., sending email/page alerts in advance (to be delivered by an appropriate electronic method) to medical personnel for follow-up care contact with the patient.

An example of a CTA system 240 is illustrated in FIG. 2B. In this system a patient 242 is positioned on a platform or table 255 between a detector 244 and an x-ray source 246. The source 246 and detector are commonly mounted on a gantry controlled by a motor 252, such that they can be rotated 248 in a circle around the patient. The scanning process can be coordinated with movement of the table 255 along separate axes to provide a three dimensional scan of the patient to provide three dimensional images of organs of the patient, such as the heart, brain, lungs, abdomen, etc. The detector 244 can be an array of detector elements having a range of 64-320, or more rows of detector elements. A preferred embodiment uses at least 64 or 128 rows of detectors. Another preferred embodiment uses at least 320 detector rows as this enables scanning of the entire human heart or brain within a single cardiac cycle or heartbeat (prospective study). An example of a CT system is the Aquilion One available from Toshiba Medical Systems, Inc. Further details regarding the operation of a CTA system can be found in U.S. application Ser. No. 12/177,262, filed Jul. 22, 2008 and published as US 2009/0028289 on Jan. 29, 2009, the entire contents of which is incorporated herein by reference. The 320 row detector system enables scanning of the entire adult human heart or brain in a single rotation of the detector assembly. This eliminates the existence of artifacts which can occur when splicing together images from separate cardiac cycles. This can significantly reduce the amount of radiation received by the patient. The present system also incorporates the selection of the imaging modality, scan parameters including the dose (Kilovolts, Milliamps for x-ray source), the amount of contrast agent, scan volume, blood pressure, heart rate, automated procedures to adjust for arrhythmias, to select exposure time based on heart rate, and coordinate the scan to the contrast agent arrival time.

In CTA systems, a cardiac sensor 257 can be used to provide electro-cardiographic signals from circuit 254 to the central processor 262. The processor can be programmed to control the x-ray source controller 256, gantry 252, table 255 in combination with sensor 254 to provide one or more 3D scans of the human heart timed the cardiac cycle. The system 240 can include the CT scanner assembly 225 and a camera 275 used to provide a live video feed and recording of the room in which the procedure takes place, and the control system workstation 241. Image data are collected at collection unit 250, forwarded to image processor 267 and stored at image storage device 268. The processor 262 is connected to a user workstation with a user control panel 264 and display 266. The system can be connected to a hospital network via network connection 270. The hospital server 272 is interfaced to emergency department workstations 276, to internal expert workstation 274 and through internet portal 278 by wired connection to remote expert workstation 282 or by wireless transmission to mobile computing device 280 having control panel 284 and display 286. Thus, devices 280, 282 are able to observe data entry onto the dashboard as described herein and observe the diagnostic sequence and imaging protocol of the system, and to remotely view images during acquisition and thereafter. Thus, a physician using device 280 can remotely participate, approve or alter steps in the procedure.

In embodiments of the present invention, the various graphical user interfaces provided to a user are made relatively simple to read, such that minimal effort need be made in order to transmit/enter data/learn information in an efficient manner.

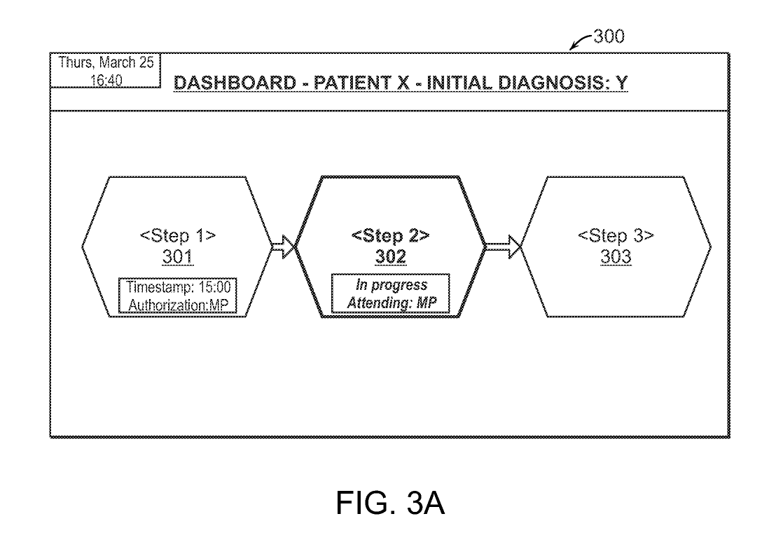

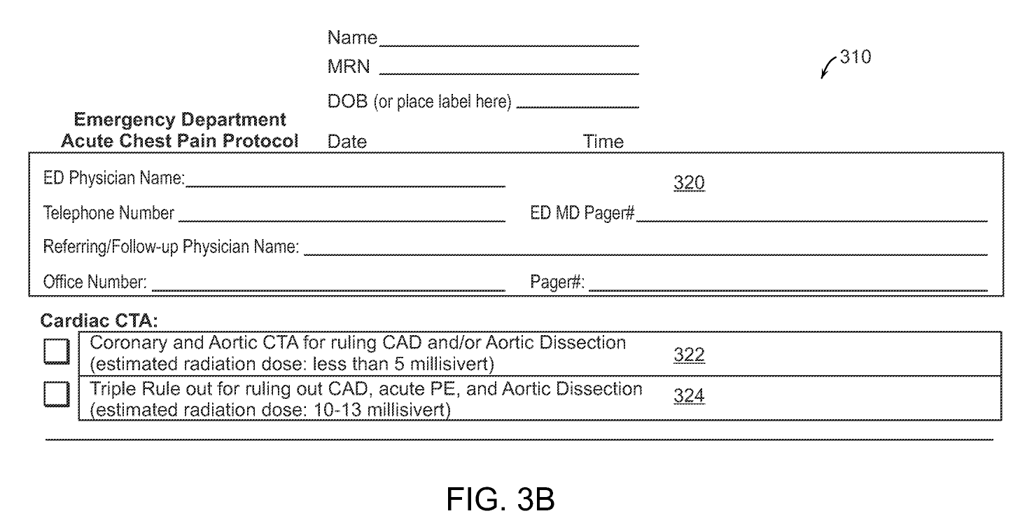

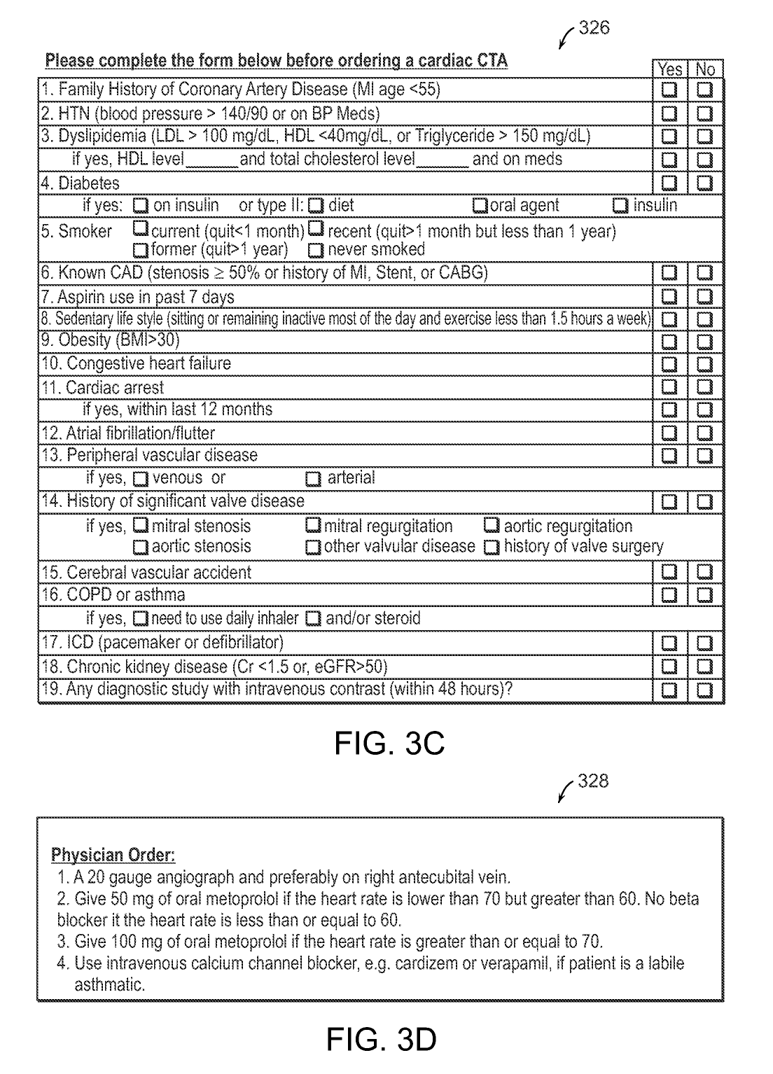

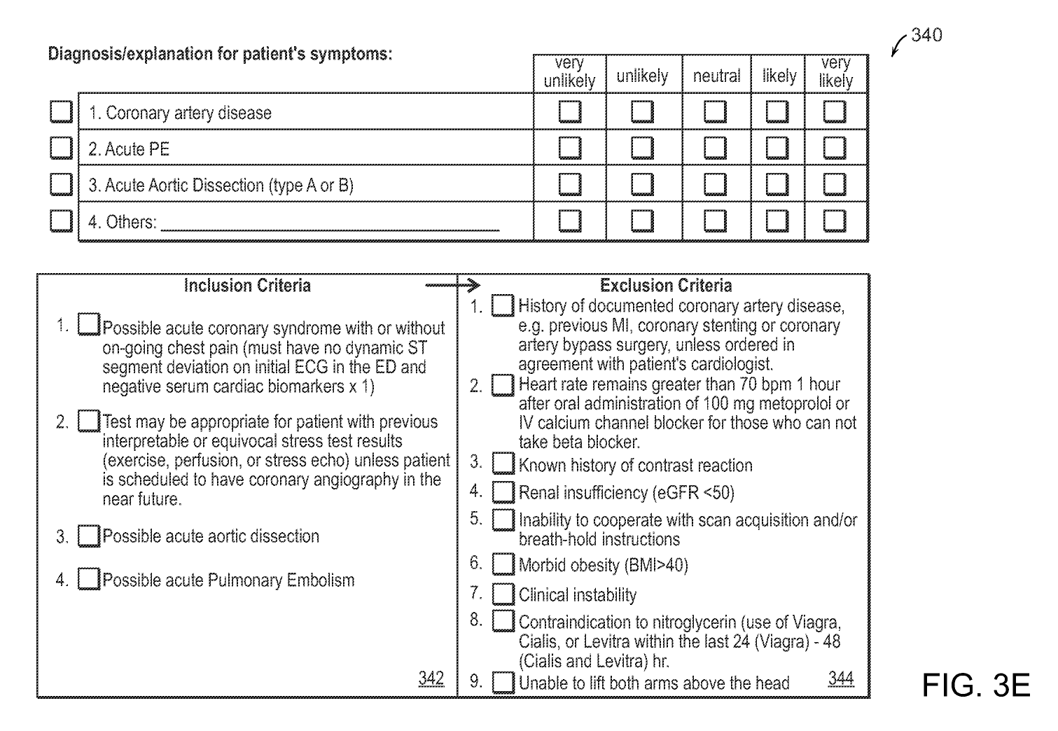

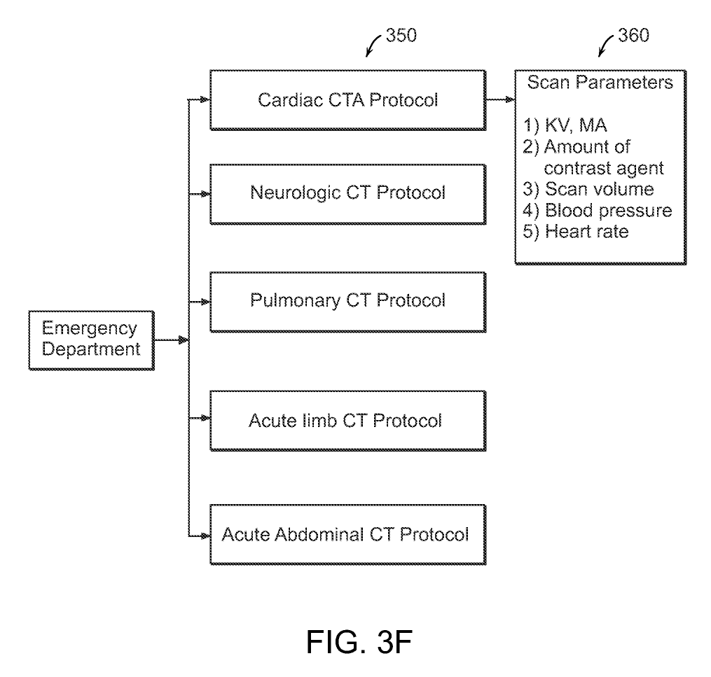

FIG. 3 shows an example dashboard 300 identifying all or some of the procedural steps 301, 302, 303, as well as identifying the current in-progress step 302 which can be differentiated by a notation, different color, different line weighting, extra graphics, and/or other method. This allows medical personnel to see immediately the current status, here “in progress,” of the procedure. In embodiments, for each step completed, e.g., Step 1 (301), a timestamp may be displayed as well as the identification (here, shown as initials) of the medical personnel authorizing the completion of the step. In embodiments, the dashboard or monitor displays—for clarity sake—the patient's identification, here “Patient X” (e.g., name, code, etc.), as well as the initial diagnosis, here “Initial Diagnosis: Y,” being investigated. In embodiments, the various items shown in addition on the dashboard can include a clock, calendar, an indication of the availability of certain medical personnel, a picture of the patient for identification, a copy of the patient's EMR, etc.

FIG. 3B shows an initial screen for the cardiac CTA protocol. The user can enter patient data 310, physician data 320, and can select a first imaging protocol 322 for CAD and/or aortic dissection at a first radiation dosage level or a second imaging protocol 324, such as the “triple rule out” that further includes acute pulmonary embolism (PE) which can require a higher second radiation dosage.

FIG. 3C illustrates a further screen indicating 19 criteria used in the initial risk assessment for the cardiac CTA protocol. Protocols for other acute condition presenting to an emergency department can include a list of plurality of criteria 326 used to determine the diagnostic sequence. Another preferred embodiment employs a neurologic protocol for scanning of the brain for acute conditions, such as stroke. A brain scan for the stroke protocol can be taken in less than 5 minutes with reduced radiation dose and without the need for an MRI. A perfusion map of blood flow to the entire brain can be obtained without motion artifacts. A CT system having a 16 cm volume capability can identify clot location by a single perfusion scan and can segment the scan into high and low resolution regions to provide high resolution images of small vascular features. Another preferred embodiment utilizes a pulmonary protocol for patients presenting with shortness of breath, for example, that can be used to diagnose a pulmonary embolism. Another embodiment providing an acute abdominal protocol. A further embodiment provides an acute limb protocol.

FIG. 3D is an example of a physician's order for medication administration 328 in conjunction with the CTA procedure. This data is inserted and saved on the system along with a window confirming delivery of the medication by a nurse or physician The initial diagnosis 340 shown in FIG. 3E. Screen shots can include the inclusion criteria 342 followed by the exclusion criteria 344 that might restrict, delay or prevent the use of a particular type of scan or medication.

As shown in FIG. 3F, an emergency department can be presented with any number of acute conditions which the present system is configured to address. Once a patient's initial symptoms are determined and entered into the system, a particular protocol 350 is selected from a plurality of protocols as described herein. Upon protocol selection, the protocol drives the selection of the appropriate plurality of scan parameters. Protocol and scan parameter selection is partially automated to prevent or minimize the risk of error. For example, if the heart rate is too fast, this would prevent the selection of a prospective imaging sequence, which may necessitate the selection of a retrospective imaging sequence which can have a higher radiation dose.

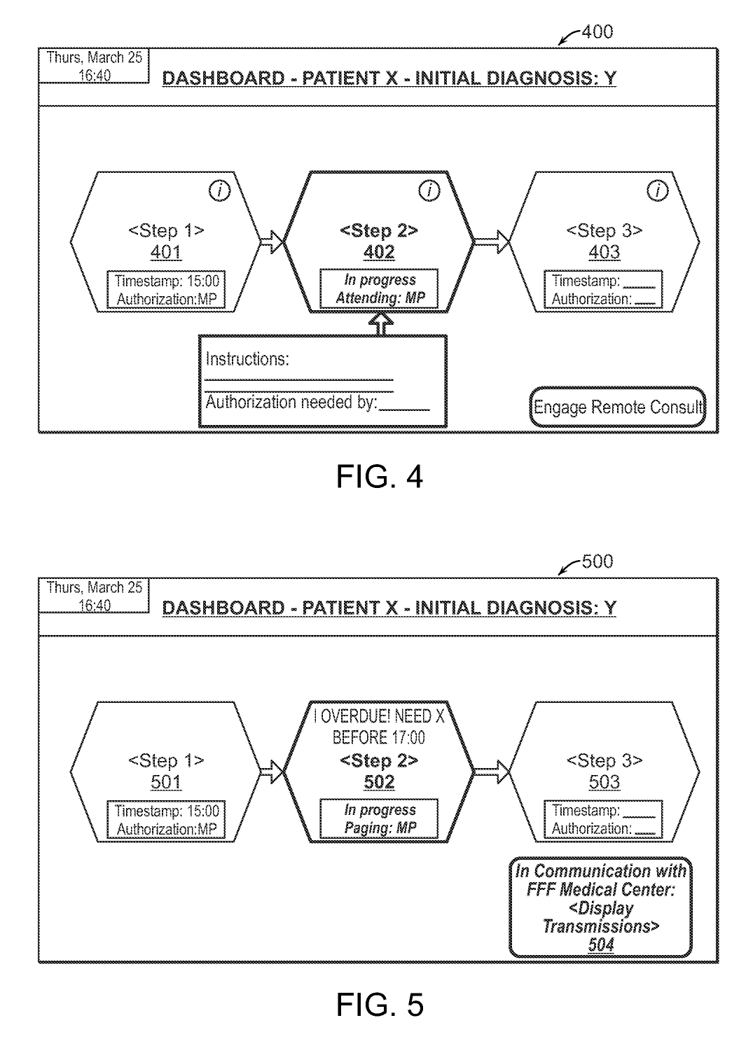

FIG. 4 shows an example dashboard 400 having a pop-up interface according to an embodiment of the present invention. In this embodiment, the various steps 401, 402, 403 are shown with information “i” notations. This, or another symbol(s), can be used to denote an interactive point, which, when pressed or clicked or activated, connects one with more information relevant to that step or notation. For example, if Step 2 (402) involved use of an imaging device, then by clicking on the “i” notation, a window or screen would appear which, e.g., highlights the instructions for using the imaging device, troubleshooting tips, cautions and/or reminders, and/or the authorization/authorized person/authorization status level needed for completion. In embodiments, an interactive touch can be provided to activate software to initiate a call, online messaging connection, and/or other communication with a remote medical person or center.

FIG. 5 shows an example dashboard 500 having an additional screen 504 or section which provides a written and/or oral communication with a remote person/location, here the FFF Medical Center, according to an embodiment of the present invention. In Step 2 (502), an alert is displayed indicating that a specific event is overdue and/or about to be overdue. Such notifications may be accompanied by an audible sound, e.g., a beep, or may initiate an automatic page, email, telephone call, and/or communication. For example, if a specific doctor is needed to analyze the test scans, or if a specific technician is required to prepare the imaging device, the needed party can be alerted by the dashboard or other system. In embodiments, the dashboard displays other information from medical personnel and/or remotely located experts. In embodiments, the dashboard has detailed instructions regarding the use of a specific imaging device needed for the diagnostic test. Such instructions are accessible by a qualified person. In embodiments, the dashboard shows authorization and timestamps for the various steps of the procedure. In embodiments, a remote medical personnel can observe and/or quality control a procedure by watching the continuously updated dashboard. In embodiments, a remote medical personnel can assist in updating or providing information to the dashboard regarding a specific perceived diagnosis and/or final diagnosis.

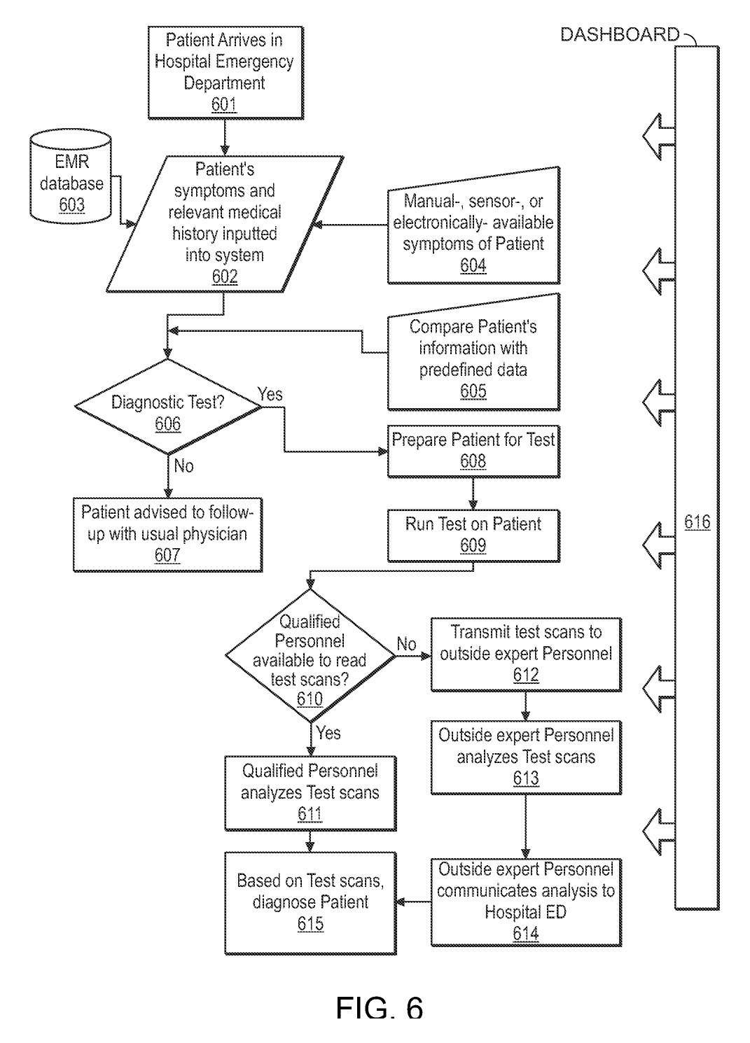

FIG. 6 shows an example flowchart of an embodiment of the present invention. For example, a patient arrives at the emergency department of a hospital 601 for possible treatment. In order to efficiently diagnose the patient, the patient's symptoms are ascertained 604 and the electronic medical record 603 is obtained 602. For example, a file or other method can be used to store the patient's personal information. In embodiments, the patient's information is compared with predefined data 605. For example, the predefined data is a database of symptoms for various diseases and/or conditions. Such conditions include, for example, genetic history of an individual, habits (e.g., smoking), and preexisting diseases/situation (e.g., diabetes, one working kidney, allergies, asthma). In embodiments, the predefined data is used to determine or assist in determining an initial diagnosis of the patient's current possible ailment. For example, based on a medical personnel's determination, the comparison result with the predefined data, or a combination of the two, a diagnostic test is either determined warranted or not warranted 606. If a diagnostic test is not warranted, the patient may be treated for what is diagnosed to be a lesser ailment and/or sent home. Depending upon the circumstances, the patient may be advised to follow-up with his or her general practitioner after a certain length of time 607. If the diagnostic test is warranted for one or more specific ailments, then the patient is prepared for the diagnostic test 608. For example, a dye and/or drug is administered to the patient, e.g., by an electronic machine controlled by the emergency department personnel and/or processor. The diagnostic test is then run on the patient 609. If a qualified personnel is available to read the test results 610, e.g., image scans, or if the department uses an electronic system to read the test scans in an accurate manner, then that takes place 611. And, based on the test scans, the patient may be diagnosed 615 as having or not having a certain ailment. If a qualified personnel is not available to read the test results 610, then the test results are transmitted to an alternate resource 612. For example, the image scans are emailed and/or viewed via a network sharing application or system to an expert. In embodiments, the expert is a team of qualified medical personnel at a medical center, a qualified medical personnel in another department at the same hospital, etc. The outside expert then analyzes the test scans 613 and communicates that analysis confidentially to the hospital emergency department 614. Based on that analysis and/or based on the hospital's system and/or personnel, the patient is diagnosed 615. Throughout the entire or part of the entire procedure, a dashboard 616 or monitor or other method is used. In embodiments, once a file is created in the system for the patient, the patient's symptoms and other information is available, as well as the patient's EMR, and can be viewed on a dashboard display. In embodiments, the dashboard 616 displays all or some of the steps of the procedure from initial diagnosis to confirmed diagnosis. In embodiments, the dashboard displays timing information, including delays, deadlines (e.g., for administration of drug, test, communication with a medical personnel), test results, availability of needed medical personnel, availability of needed machine(s) (e.g., CTA or other imaging machine). In embodiments, the dashboard 616 is viewable on a mobile device or a portable device. In embodiments, the dashboard 616 is viewable by a remote center. In embodiments, the dashboard 616 is viewed by supervising medical personnel. In embodiments, the dashboard 616 is an interactive device allowing for input. In embodiments, the dashboard 616 is updated in real-time. In embodiments, the dashboard 616 is updated asynchronously. In embodiments, the dashboard 616 is updated at specific time intervals. In embodiments, the functions of the dashboard, e.g., alerts, identification of the current step, can be modified by an authorized user for that specific monitor's use. In embodiments, the dashboard 616 is connected to a telephone system, video conferencing system, WAN, LAN, VoIP connection, and/or other communication system.

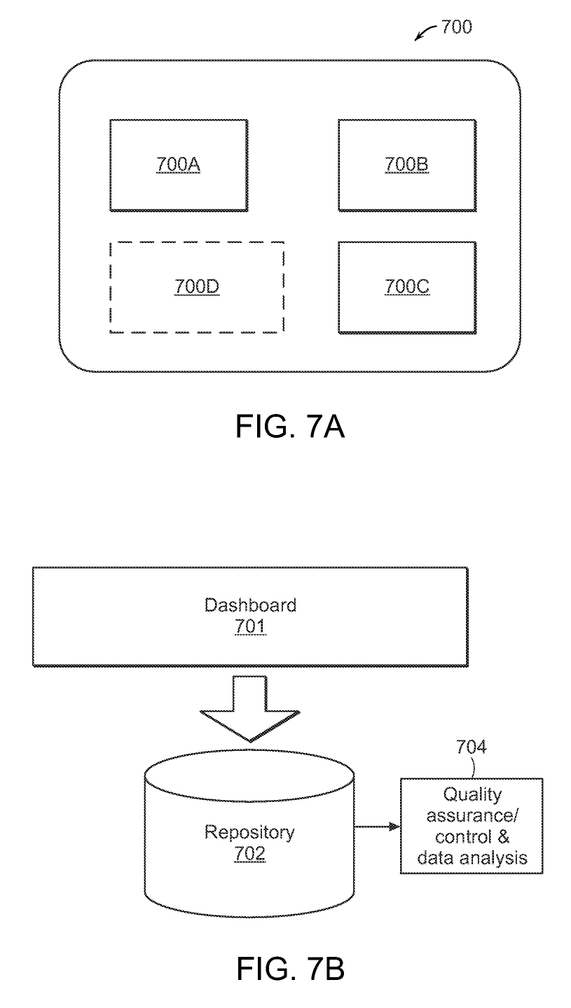

In connection with the step of running the diagnostic procedure 609 on the patient, this step can be remotely monitored 208 as shown in FIG. 2A, for example. This monitoring step is accessed via dashboard 616 where the user can access the monitoring interface on a display. FIG. 7A illustrates a screen shot of the monitoring step wherein three windows are used for monitoring of a procedure. Window 700A can display the live video feed from the camera 275 that is used to view the room in which the procedure is occurring. Window 700B displays the scan image as it is occurring and shows scan details on the screen of the medical technician conducting the scan. Window 700C can display the windows, such as those shown in FIGS. 3A-3E described herein, so that the remote monitor user can view the entire history of the patient's visit.

FIG. 7B shows an example diagram of an embodiment of the present invention. A monitor, dashboard, or display means 701 is associated with a repository 702. This embodiment can be used with any of the embodiments described herein, or other embodiments according to the present invention. For example, any and/or all of the data accessible by the monitor 701 can be forwarded to the repository 702 for storage, later use and manipulation. For example, one or more of the various steps displayed and/or tracked on the monitor 701 can be downloaded to a repository 702.

In embodiments, the information displayed and/or available for display on the monitor 701 is transmitted to the repository 702. In embodiments, one or more of the alerts, timestamps, authorizations, delays, and other features are transmitted to the repository 702. In embodiments, data is transmitted to the repository 702 in at least one of: wirelessly, wired connection, portable storage means, manually, and automatically. For example, when new data is entered into the system which is displayed on the monitor 701, the new data is automatically transmitted wirelessly to a remote repository 702 and/or to another storage means hard-wired 702 to the monitor 701. In embodiments, the repository 702 is used to store and safe-keep the data for statistical use.

In embodiments, the repository 702 is used in the generation of report(s). For example, such report(s) include an efficiency report on the personnel at a hospital, an efficiency report on the use of the monitor system and/or remote assistance. For example, such report(s) include a cost report on the use of certain resources (e.g., imaging machines, network, medical personnel, instruments, video conferencing system, etc.). For example, such report(s) include a report on the effectiveness of the use of certain devices in specific situations. For example, such report(s) include a report on the effectiveness of the use of CTA in the accurate and efficient diagnosis of heart disease. For example, such report(s) include a report on the effectiveness of the use of a dashboard and the medical center/hospital ED's established protocol(s). Thus a data analysis and reporting step 704 can be used for quality assurance and quality control functions.

In embodiments, the repository 702 can be represented as one or more of the following: database, server, cache, flash drive, portable storage means, DVD, CD-ROM, multiple electronic storage devices and/or methods, and other storage means. In embodiments, the repository 702 can be configured to have an application (e.g., a software application), or an association with an application, which pulls information from the monitor 701 and/or receives pushed information from the monitor 701. In embodiments, the repository 702 is a plurality of repositories.

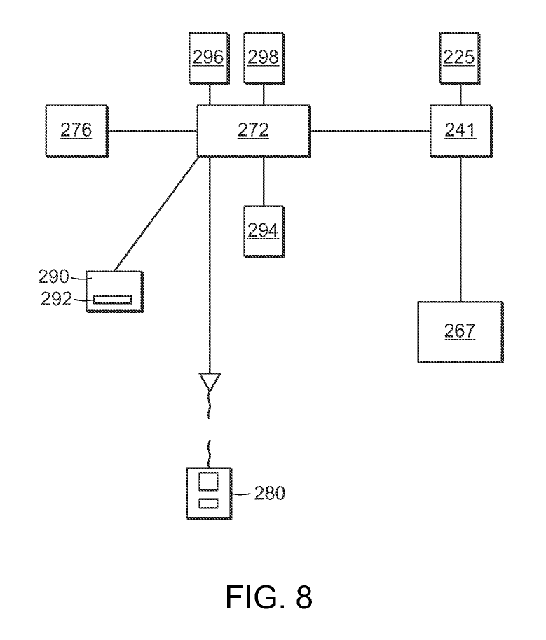

The system shown in FIG. 8 further includes additional diagnostic systems, such as ultrasound 296 and MRI 298 systems, that can be linked to the server and the medical records storage system 294. The server 272 can also be linked to a separate workstation having a diagnostic processor 292. The diagnostic processor 292 can be programmed to perform specific diagnostic or scan parameter selection functions depending on the particular protocol being utilized. The processor 292 can, for example, based on the medical history of the patient, calculate specific scan parameters which are then forwarded to the scanner workstation to conduct a particular scan. The dashboard can also be accessed to remotely monitor the ultrasound, MRI or other diagnostic procedures as described previously in connection with the remote CTA procedure. The system can also be accessed from a surgical room at the clinic or hospital.

In embodiments, the transmissions of a patient's or other's information to and from the dashboard and/or remote medical personnel are handled in a confidential communication manner as needed by the information involved. For example, the transmissions of data are encrypted by any number of available methods, e.g., public key encryption, certificate, etc. Or, for example, a dedicated and secure transmission channel may be open for the transmission of unencrypted and/or encrypted data.

It should be understood that there exist implementations of other variations and modifications of the invention and its various aspects, as may be readily apparent to those of ordinary skill in the art, and that the invention is not limited by specific embodiments described herein. Features and embodiments described above are combinable with and without each other. It is therefore contemplated that the present invention covers any and all modifications, variations, combinations or equivalents that fall within the scope of the basic underlying principals disclosed and claimed herein.

1. A network system for implementation of a medical procedure, comprising:
a diagnostic scanning system for imaging a patient, the system including an image scanner and a processor that processes image data; and
a medical record system connected to the diagnostic scanning system with a communication network, the medical record system having a memory for storing medical record data and a patient management system having a graphical user interface for entering patient data; and
determining scan parameters to be transmitted to the scanning system using the patient management system.

2. The system of claim 1 further comprising at least one activity monitoring dashboard, the activity monitoring dashboard displaying real-time execution of a medical procedure with the diagnostic scanning system, the procedure including:
entering patient data for a diagnostic test, the patient being located in a first location,
conducting a diagnostic test,
transmitting resulting data of the diagnostic test to at least one second location,
reviewing the diagnostic test at the at least one second location,
transmitting a resulting review determination from the at least one second location to the first location; and
storing the diagnostic test result in a repository.

3. The system of claim 2, wherein the activity monitoring dashboard has an interactive screen so that additional information can be displayed for steps of the procedure.

4. The system of claim 2, wherein the repository is located at least at one of the first location, the at least one second location, and a third location, and
further comprising: a report generating system for generating at least one report from data located in the repository concerning at least one of: efficiency of the procedure of the method steps; frequency of diagnostic testing; timing of care for the entity; transmission of data; resulting review determinations based on a specific diagnostic test result; cost of each of the method steps; cost effectiveness of the procedure; and transmission of determinations.

5. The system of claim 1, further comprising:
a software system implemented by a data processor associated with the medical record system to provide a record system graphical user interface via an activity monitoring dashboard displaying least one procedure specific to a set of recorded symptoms of the patient,
wherein the software system is updatable to include information regarding the at least one procedure specific to the set of recorded symptoms of the patient, the information including at least one of appropriate use guidelines, exclusionary criteria, predetermined timing data for respective steps of the at least one procedure, an alert if a procedure step exceeds a respective predetermined time data limit.

6. The system of claim 5, further comprising:
a portable mobile device, the portable mobile device being configured to display the activity monitoring dashboard in real-time.

7. The system of claim 6, wherein the activity monitoring dashboard allows for access to and monitoring of an electronic medical record associated with the patient, a physician ordering system specific to a health care institution, use criteria data identifying a diagnostic test or intervention for specific symptoms and medical history, alert for any exclusionary criteria for the diagnostic test or intervention, and alert for one or more critical checkpoints of the procedure.

8. The system of claim 1 further comprising a processor readable medium that stores code representing instructions to cause a processor to perform a diagnostic process.

9. The system of claim 8 wherein the processor comprises a diagnostic processor of the medical record system.

10. The system of claim 1 wherein the graphical user interface includes a plurality of protocols, each protocol defining a plurality of scan parameters associated with the protocol.

11. The system of claim 10 wherein at least a first protocol comprises a cardiac computed tomography protocol.

12. The system of claim 10 wherein at least a second protocol comprises a neurological computed tomography protocol.

13. The system of claim 10 wherein at least a third protocol comprises a pulmonary computed tomography protocol.

14. The system of claim 10 wherein at least a fourth protocol comprises an abdominal computed tomography protocol.

15. The system of claim 10 wherein at least a fifth protocol comprises a limb computed tomography protocol.

16. The system of claim 10 wherein each of the plurality of protocols has an associated plurality of scan parameters.

17. The system of claim 16 wherein a first scan parameter comprises a voltage for an x-ray source.

18. The system of claim 16 wherein a second scan parameter comprises a current of the x-ray source.

19. The system of claim 16 wherein a third scan parameter comprises a type and amount of contrast agent.

20. The system of claim 16 wherein a fourth scan parameter comprises a scan volume within the patient.

21. The system of claim 16 wherein a fifth scan parameter comprises blood pressure of a patient.

22. The system of claim 16 wherein a sixth scan parameter comprises heart rate of a patient.

23. The system of claim 1 wherein the diagnostic scanning system comprises a computed tomography device.

24. The system of claim 23 wherein the computed tomography device has at least 64 detector rows.

25. The system of claim 23 wherein the computed tomography device has at least 128 detector rows.

26. The system of claim 23 wherein the computed tomography device has at least 320 detector rows.

27. The system of claim 23 further comprising a cardiac sensor.

28. The system of claim 27 wherein the cardiac sensor comprises an ECG sensor.

29. The system of claim 1 further comprising a remote monitoring system.

30. The system of claim 29 wherein the monitoring system comprises a display to display the graphic user interface having a first display window to display an image generated by the diagnostic scanning system during and after image acquisition.

31. The system of claim 30 further comprising a second display window displayed simultaneously with the first display window, the second display window displays a patient dashboard displaying patient data.

32. The system of claim 30 further comprising a third display window displayed simultaneously with the first display window and a second display window, the third display window displaying video images detected by a video camera recording a diagnostic scanning process of a patient.

33. The system of claim 30 wherein the display comprises a flat panel display of a wireless handheld computing device.

34. The system of claim 30 further comprising a fourth display for communicating with a display of the diagnostic scanning system.

35. The system of claim 20 wherein the scan volume comprises a patient's heart to form a three dimensional image of the entire heart in a single cardiac cycle.

36. The system of claim 8 wherein the process comprises executing a cardiac protocol including coronary and aortic regions of a patient's heart.

37. The system of claim 8 wherein the process comprises coronary, pulmonary and aortic regions of the patient.

38. The system of claim 1 wherein the medical record system comprises a hospital server connected to the diagnostic scanning system with a network connector.

39. The system of claim 1 wherein the diagnostic scanning system further comprises an ultrasound system or a magnetic resonance imaging system, each system having a plurality of scanning protocols.

40. A method for reviewing diagnostic events, comprising:
identifying a patient for diagnostic test, the patient being located in a first location;
conducting a diagnostic test;
transmitting resulting data of the diagnostic test to at least one second location;
reviewing the diagnostic test at the at least one second location;
transmitting a resulting review determination from the at least one second location to the first location; and
wherein a dashboard device is used to monitor the method steps.

41. The method of claim 40, wherein the diagnostic test is effected by a computed tomography (CT) machine for cardiac disease symptoms.

42. The method of claim 40, wherein the resulting review determinations transmitted from the second location to the first location include instructions regarding treatment of the patient.

43. The method of claim 40, wherein the dashboard device indicates the method steps, and indicates the currently in progress method step.

44. The method of claim 40, wherein the repository includes data of the diagnostic test and data of the method steps monitored by the dashboard device.

45. The method of claim 44, further comprising:
generating at least one report from the data in the repository concerning at least one of:
efficiency of a process of the method steps;
frequency of diagnostic testing;
timing of care for the patient;
transmission of data;
resulting review determinations based on a specific diagnostic test result; and
transmission of determinations.

46. The method of claim 44, further comprising:
observing the method steps via the dashboard device in real-time for at least one of efficiency, quality, and accuracy.

47. The method of claim 44, wherein the first location is an emergency department at a hospital, and the second location is a remote observation medical center.

48. The method of claim 44, wherein the first location is an emergency department at a medical facility, and the second location is a separate department at the same medical facility.

49. The method of claim 40 further comprising selecting one of a plurality of diagnostic protocols.

50. The method of claim 49 further comprising selecting a plurality of scan parameters for the selected protocol.

51. The method of claim 49 wherein the protocol comprises a cardiac protocol.

52. The method of claim 49 wherein the protocol comprises a neurological protocol comprising a computed tomography brain scan.

53. The method of claim 49 wherein the protocol comprises a pulmonary protocol.

54. The method of claim 40 further comprising remotely monitoring the diagnostic test using a graphical user interface having at least three simultaneously displayed windows.

55. An apparatus for remote monitoring, comprising:
a monitor, the monitor displaying in real-time execution of a procedure, the procedure including:
identifying a patient for diagnostic test, the patient being located in an emergency department;
conducting a diagnostic test;
transmitting resulting data of the diagnostic test to at least one second location;
reviewing the diagnostic test at the at least one second location;
transmitting a resulting review determination from the at least one second location to the first location; and
storing the diagnostic test result in a repository.

56. The apparatus of claim 55, wherein the monitor works as a dashboard for remote monitoring, the dashboard having an interactive screen so that additional information can be displayed for steps of the procedure.

57. The apparatus of claim 55, wherein the repository is accessed at least at the emergency department, and at least one second location and a third location.

58. The apparatus of claim 56, wherein the apparatus signals an alert if a procedure step exceeds a predetermined time limit.

59. The apparatus of claim 56, further comprising:
a software system implemented by a processor to provide a graphical interface via the dashboard displaying the at least one procedure specific to a set of recorded symptoms of the entity.

60. The apparatus of claim 59, wherein the software system is updated to include information regarding the at least one procedure specific to the set of recorded symptoms of the entity, the information including at least one of appropriate use guidelines, exclusionary criteria, predetermined timing data for respective steps of the at least one procedure, and access permission.

61. The apparatus of claim 55 connected to a hospital server via a public access network.

62. The apparatus of claim 56 further comprising connecting the monitor to a diagnostic system processor to display an image during acquisition in a display window of the dashboard.

63. The apparatus of claim 62 further comprising a second display window from a video camera.

64. The apparatus of claim 62 further comprising a third display window displaying patient data.

65. The apparatus of claim 55 further comprising a display on a wireless handheld computing device.

66. A method for performing a diagnostic medical procedure, comprising:
entering patient data into a medical record system accessed from an emergency department, the medical record system being connected to the diagnostic scanning system with a communication network, the medical record system having a memory for storing medical record data and a patient management system having a graphical user interface for entering the patient data and determining scan parameters to be transmitted to a scanning system; and
performing a diagnostic scan imaging the patient with a scanning system including an image scanner and a processor that processes image data.

67. The method of claim 66 further comprising displaying real-time execution of a medical procedure on an monitoring dashboard, the procedure including:
identifying a patient for a diagnostic test, the patient being located in a first location,
conducting a diagnostic test,
transmitting resulting data of the diagnostic test to at least one second location,
reviewing the diagnostic test at the at least one second location,
transmitting a resulting review determination from the at least one second location to the first location; and
storing the diagnostic test result in a repository.

68. The system of claim 67, further comprising using an interactive screen of the dashboard so that additional information can be displayed for steps of the procedure.

69. The method of claim 67 further comprising:
generating at least one report from data located in the repository concerning at least one of: efficiency of the procedure of the method steps; frequency of diagnostic testing; timing of care for the entity; transmission of data; resulting review determinations based on a specific diagnostic test result; cost of each of the method steps; cost effectiveness of the procedure; and transmission of determinations.

70. The method of claim 66 further comprising:
using a software system implemented by a processor associated with the medical record system to provide a graphical interface via an activity monitoring dashboard displaying the at least one procedure specific to a set of recorded symptoms of the entity,
wherein the software system is updatable to include information regarding the at least one procedure specific to the set of recorded symptoms of a patient, the information including at least one of appropriate use guidelines, exclusionary criteria, predetermined timing data for respective steps of the at least one procedure, an alert if a procedure step exceeds a respective predetermined time data limit.

71. The method of claim 66 further comprising displaying a dashboard on a portable mobile device, the portable mobile device being configured to display an activity monitoring dashboard in real-time.

72. The method of claim 66 further comprising storing code on a processor readable medium, the code including instructions to cause a processor to perform a diagnostic process.

73. The method of claim 66 further comprising displaying a plurality of protocols on a graphical user interface, each protocol defining a plurality of scan parameters associated with the protocol.

74. The method of claim 73 further comprising performing a first protocol including a cardiac computed tomography protocol.

75. The method of claim 73 further comprising performing a second protocol including a neurological computed tomography protocol.
